(19) United States
(12) Patent Application Publication
(10) Pub. No.: US 2018/0159875 A1
(43) Pub. Date: Jun. 7, 2018

(54) Using electronic game as means of data acquisition

(71) Applicant: Roman Potapov, Durham, NC (US)

(72) Inventor: Roman Potapov, Durham, NC (US)

(73) Assignee: Roman Potapov, Durham, NC (US)

(21) Appl. No.: 15/368,594

(22) Filed: Dec. 3, 2016

(51) Int. Cl. H04L 29/06; G06N 99/00; A63F 13/79; A63F 13/67

(52) U.S. Cl. CPC H04L 63/1425; A63F 13/67; A63F 13/79; G06N 99/005

(57) ABSTRACT

Special electronic cyber security simulator game with programmable real-life situations will allow collection of sufficient quantity of controlled attacker behavior data as well as complete labeling of that data at any degree of granularity which can greatly facilitate machine learning and artificial intelligence development in the field of cyber security.

### CROSS-REFERENCE TO RELATED APPLICATIONS

Not Applicable

### STATEMENT REGARDING FEDERALLY SPONSORED RESEARCH OR DEVELOPMENT (IF APPLICABLE) Not Applicable

### REFERENCE TO SEQUENCE LISTING, A TABLE, OR A COMPUTER PROGRAM LISTING COMPACT DISC APPENDIX OF APPLICABLE)

Not Applicable

### BACKGROUND OF THE INVENTION

Acquisition of data of sufficient quality in sufficient quantities so as to permit proper machine learning is one of the problems of the modern data science. Information security and threat detection are two fields where this problem is particularly significant. Most of perpetrators leave only traces of their actions which do not permit full restoration of their tactics tools and procedures. A huge variability of computer methods and logical locations present another problem hampering development of impressive machine learning and artificial intelligence capable of matching skilled perpetrators: lack of possibilities of labeling data in the datasets suitable for machine learning.

Both problems stem from the lack of control over the environment in which the computer crime occurs, both logically and chronologically. This invention should provide the scientists with the sufficient types and quantities of accurately labeled data generated in pre-programmed and controlled environment to be perfectly suitable for successful machine learning and artificial intelligence development in information security realm.

### BRIEF SUMMARY OF THE INVENTION

The author proposes using a computer game, specifically crafted for security data collection. Computer game may mean a game for any device. Data collection would not extend to personal data. Stages of the game will resemble real computer environments closely and will be enumerated in order to provide labels for machine learning. All data will be extractable for the purpose of analysis and machine learning.

### DETAILED DESCRIPTION OF THE INVENTION

A special game will be designed with programmable game situations closely resembling logical and physical composition of modern computer and electronic environment in all aspects of life. Players will be allowed to used symbolic tools and means resembling those of the cyber attackers and defenders in order to proceed through the game and win achievements. Players will have a choice of either attacking or defending side, namely, either hackers or security professionals.

Every step and choice within the game will be clearly and uniquely marked in the underlying program allowing for immediate identification of any aspect of the character played in the game. These markers will be the basis for data labeling necessary for machine learning. The game will be interesting and popular and will be played by participants of various backgrounds either against each other or against the program globally.

The game will allow to collect tactics tools and procedures that an intelligent person (player) would use in order to achieve the game goals. Enough players will play to generate millions of labeled information security use-cases.

That information will be extremely valuable for further analysis including machine learning and artificial intelligence. That will allow to build an automated solution capable of counteracting human attackers in the cyberspace.

1. The invention will allow collection of sufficient quantity of controlled attacker behavior data to allow further effective use against the cyber threats.
The invention will allow complete labeling of data at any degree of granularity which can greatly facilitate machine learning and artificial intelligence development in the field of cyber security.
